(19) United States
(12) Patent Application Publication
(10) Pub. No.: US 2025/0332848 A1
(43) Pub. Date: Oct. 30, 2025

(54) DRYING DEVICE AND PRINTING SYSTEM

(71) Applicant: SEIKO EPSON CORPORATION, Tokyo (JP)

(72) Inventors: Hideto YAMASHITA, SUWA-SHI (JP); Manabu SUZUKI, MATSUMOTO-SHI (JP); Seigo MIZUTANI, MATSUMOTO-SHI (JP); Katsuya ASAMOTO, MATSUMOTO-SHI (JP); Tsuneyuki SASAKI, MATSUMOTO-SHI (JP)

(21) Appl. No.: 19/187,428

(22) Filed: Apr. 23, 2025

(30) Foreign Application Priority Data
Apr. 25, 2024 (JP) 2024-071500

(51) Int. Cl. B41J 11/00; B41M 7/00

(52) U.S. Cl. CPC B41J 11/00212; B41J 11/00216; B41J 11/00218; B41M 7/009

(57) ABSTRACT

A drying device includes a drying furnace into which a medium 99 to be transported enters, a heating section 48 that heats the medium in the drying furnace, wherein the heating section has an upstream heating mechanism 55, a downstream heating mechanism 56 located downstream from the upstream heating mechanism in a transport direction D1 of the medium, and an intermediate heating mechanism 57 located between the upstream heating mechanism and the downstream heating mechanism in the transport direction, the upstream heating mechanism has an upstream heating member located so that a distance between the upstream heating member and the medium is a predetermined distance, the downstream heating mechanism has a downstream heating member located so that a distance between the downstream heating member and the medium is larger than the predetermined distance, the intermediate heating mechanism has an intermediate heating member located so that a distance between the intermediate heating member and the medium is larger than the predetermined distance, a set temperature of the upstream heating member is higher than a set temperature of the intermediate heating member, and the set temperature of the downstream heating member is higher than the set temperature of the intermediate heating member.

The present application is based on, and claims priority from JP Application Serial Number 2024-071500, filed Apr. 25, 2024, the disclosure of which is hereby incorporated by reference herein in its entirety.

### BACKGROUND

### 1. Technical Field

The present disclosure relates to a drying device and a printing system.

### 2. Related Art

JP-A-2020-2473 describes a drying device in which a medium is heated by a heating section. The drying device dries the medium by heating the medium.

In such a drying device, it is required to rapidly raise the temperature of the medium in order to effectively dry the medium. If a set temperature of the heating section is high, the temperature of the medium rises rapidly. On the other hand, if the set temperature of the heating section is high, there is concern that the medium may be excessively heated. In this case, the medium may be deteriorated.

### SUMMARY

In order to overcome the above problems, a drying device includes a drying furnace into which a medium to be transported enters and a heating section that heats the medium in the drying furnace, wherein the heating section has an upstream heating mechanism, a downstream heating mechanism located downstream from the upstream heating mechanism in a transport direction of the medium, and an intermediate heating mechanism located between the upstream heating mechanism and the downstream heating mechanism in the transport direction, the upstream heating mechanism has an upstream heating member located so that a distance between the upstream heating member and the medium is a predetermined distance, the downstream heating mechanism has a downstream heating member located so that a distance between the downstream heating member and the medium is larger than the predetermined distance, the intermediate heating mechanism has an intermediate heating member located so that a distance between the intermediate heating member and the medium is larger than the predetermined distance, a set temperature of the upstream heating member is higher than a set temperature of the intermediate heating member, and a set temperature of the downstream heating member is higher than the set temperature of the intermediate heating member.

In order to overcome the above problems, a printing system includes a printing device for printing an image on a medium, and a drying device that dries a printed medium, wherein the printing device has a housing and a printing section configured to print an image on the medium within the housing, the drying device has a drying furnace into which the medium transported from the printing device enters and a heating section that heats the medium in the drying furnace, the heating section has an upstream heating mechanism, a downstream heating mechanism located downstream from the upstream heating mechanism in a transport direction of the medium, and an intermediate heating mechanism located between the upstream heating mechanism and the downstream heating mechanism in the transport direction, the upstream heating mechanism has an upstream heating member located so that a distance between the upstream heating member and the medium is a predetermined distance, the downstream heating mechanism has a downstream heating member located so that a distance between the downstream heating member and the medium is larger than the predetermined distance, the intermediate heating mechanism has an intermediate heating member located so that a distance between the intermediate heating member and the medium is larger than the predetermined distance, a set temperature of the upstream heating member is higher than a set temperature of the intermediate heating member, and a set temperature of the downstream heating member is higher than the set temperature of the intermediate heating member.

### BRIEF DESCRIPTION OF THE DRAWINGS

FIG. 1 is a side view showing an embodiment of a printing system including a drying device.

FIG. 2 is a side view of a heating section.

FIG. 3 is a sectional view of a heating member.

FIG. 4 is a graph showing a temperature change of a medium.

FIG. 5 is a graph showing the temperature change of the medium when the medium is heated under conditions different from those of FIG. 4.

### DESCRIPTION OF EMBODIMENTS

Hereinafter, an embodiment of a printing system including a drying device will be described with reference to the drawings.

### Printing System

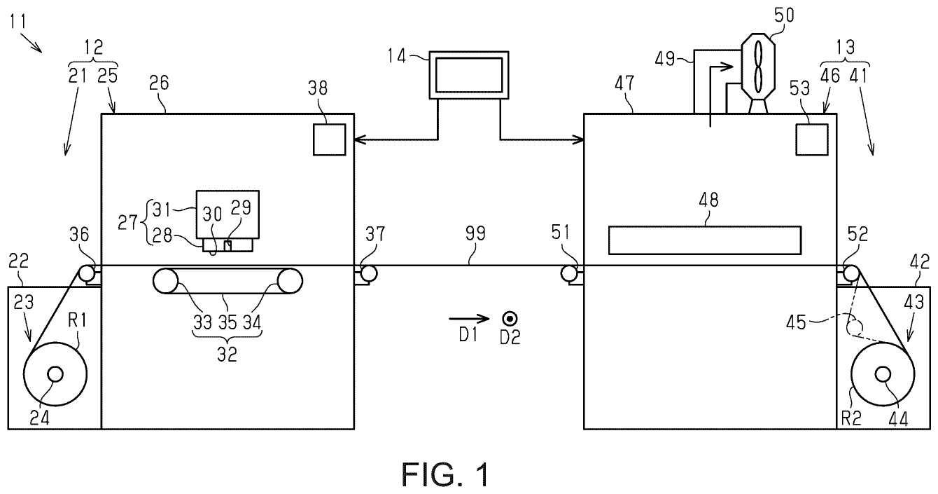

As shown in FIG. 1, a printing system 11 is equipped with a printing device 12 and a drying device 13. The printing device 12 is configured to print an image on a medium 99. The printing device 12 is, for example, an inkjet printer that prints images such as characters and photographs by ejecting ink, which is an example of liquid, onto the medium 99 such as a sheet or fabric. The drying device 13 is configured to dry the printed medium 99. Specifically, the drying device 13 dries the medium 99 by heating the medium 99. The printing system 11 performs printing and drying on an elongated medium 99 extending from the printing device 12 to the drying device 13. The printing device 12 and the drying device 13 cooperate with each other by transmitting signals to each other.

The printing device 12 and the drying device 13 are arranged in a transport direction D1. The transport direction D1 is a direction in which the medium 99 is transported from the printing device 12 to the drying device 13. In one example, the printing device 12 and the drying device 13 are arranged with intervals in the transport direction D1. This is because a user may enter between the printing device 12 and the drying device 13.

The printing system 11 is equipped with an input section 14. The input section 14 is an interface for inputting information into the printing system 11. The user operates the printing system 11 by operating the input section 14. The input section 14 is, for example, a touch panel. The input section 14 may include a button, a lever, a switch, and the like. The input section 14 may be attached to the printing device 12 or may be attached to the drying device 13. The input section 14 may be equipped in the printing device 12 or may be equipped in the drying device 13. The input section 14 may be equipped in each of the printing device 12 and the drying device 13.

### Printing Device

The printing device 12 may be equipped with a feed unit 21. The feed unit 21 is configured to feed the medium 99. The feed unit 21 feeds out the medium 99 from a roll body, for example. The roll body is an object in which the medium 99 is wound over and over.

The feed unit 21 has a feed case 22. The feed case 22 accommodates the first roll body R1. The first roll body R1 is a roll body on which the medium 99 before printing is wound over. The feed unit 21 has a feed section 23. The feed section 23 is accommodated in the feed case 22. The feed section 23 feeds the medium 99 from the first roll body R1. The feed section 23 has a feed shaft 24. The feed shaft 24 rotatably supports the first roll body R1. The feed shaft 24 may be actively rotated, may be rotated in a driven manner, or may be fixed to the feed case 22. As the first roll body R1 rotates, the medium 99 is fed out from the first roll body R1. In the feed section 23, the first roll body R1 may rotates as the feed shaft 24 rotates or may be rotated as the medium 99 is pulled.

The printing device 12 is equipped with a printing unit 25. The printing unit 25 is configured to print on the medium 99. The printing unit 25 performs printing on the medium 99 fed from the feed unit 21. The printing unit 25 may print on a medium 99 fed from another device.

The printing unit 25 has a housing 26. The housing 26 is, for example, adjacent to the feed case 22. In one example, the housing 26 is arranged with the feed case 22 in the transport direction D1. The printing unit 25 has a printing section 27. The printing section 27 is accommodated in the housing 26. The printing section 27 prints an image on the medium 99 within the housing 26. The printing section 27 performs printing on the medium 99 by ejecting liquid onto the medium 99. The printing section 27 prints on the medium 99 fed out from the feed section 23. The printing section 27 prints on the medium 99 being transported within the housing 26.

The printing section 27 has a head 28. The head 28 has a nozzle surface 30 through which one or more nozzles 29 open. The head 28 ejects liquid from the nozzles 29 onto the medium 99. The nozzle surface 30 faces the medium 99.

The printing section 27 may have a carriage 31. The head 28 is mounted on the carriage 31. The carriage 31 scans against the medium 99. In other words, in one example, the head 28 is a serial head that prints across the width of the medium 99 by scanning against the medium 99. The head 28 may be a line head capable of simultaneously ejecting the liquid across the width of the medium 99.

The printing unit 25 has a transport section 32. The transport section 32 is configured to transport the medium 99. The transport section 32 transports the medium 99 within the housing 26. In one example, the transport section 32 transports the medium 99 in the transport direction D1. In one example, the transport section 32 intermittently transports the medium 99. This is because, for example, the head 28 is a serial head. If the head 28 is a line head, the transport section 32 may continuously transport the medium 99.

The transport section 32 is accommodated in the housing 26. The transport section 32 transports the medium 99 fed from the feed section 23. The transport section 32 may cause the feed section 23 to feed the medium 99 from the first roll body R1 by pulling the medium 99. The transport section 32 faces the printing section 27. In one example, the transport section 32 is located directly below the printing section 27.

The transport section 32 transports the medium 99 at a predetermined transport speed. The transport speed is indicated, for example, by an average speed of the medium 99. The transport speed is set, for example, by the user operating the input section 14.

The transport section 32 has a first pulley 33, a second pulley 34, and a belt 35. The first pulley 33 and the second pulley 34 are arrange, for example, in the transport direction D1. The belt 35 is wound around the first pulley 33 and the second pulley 34. The belt 35 rotates together with the first pulley 33 and the second pulley 34.

The belt 35 supports the medium 99. Specifically, the belt 35 is configured to attract the medium 99. In one example, the belt 35 attracts the medium 99 with an adhesive. An adhesive is applied to the surface of the belt 35. The belt 35 holds the medium 99 by attracting the medium 99. By this, the posture of the medium 99 is stabilized. The belt 35 may attract the medium 99 by, for example, static electricity, or may attract the medium 99 by negative pressure due to suction. As the belt 35 rotates while attracting the medium 99, the medium 99 is transported. The transport section 32 is not limited to transporting the medium 99 by the belt 35, and may transport the medium 99 by rollers, for example.

The printing unit 25 may have one or more print guide rollers. In one example, the printing unit 25 has a first print guide roller 36 and a second print guide roller 37. The print guide roller is configured to guide the medium 99. The print guide roller guides the medium 99 by making contact with the medium 99. The print guide roller guides the medium 99 from the feed unit 21 to the printing unit 25 and guides the medium 99 from the printing device 12 to the drying device 13.

The print guide roller may be located inside the housing 26 or outside the housing 26. In one example, the first print guide roller 36 and the second print guide roller 37 are located outside the housing 26. The first print guide roller 36 guides the medium 99 so that the medium 99 is supplied into the housing 26 from the outside of the housing 26, for example. In one example, the first print guide roller 36 guides the medium 99 fed from the feed section 23 into the housing 26. For example, the second print guide roller 37 guides the medium 99 so that the medium 99 is discharged from the inside of the housing 26 to the outside of the housing 26. Specifically, the second print guide roller 37 guides the printed medium 99 to the outside of the housing 26.

The printing unit 25 has a print control section 38. The print control section 38 controls the printing unit 25. Specifically, the print control section 38 controls the printing section 27 and the transport section 32. The print control section 38 may control the feed unit 21 in addition to the printing unit 25. The print control section 38 may control the feed section 23, for example.

The print control section 38 may be composed of one or more processors that execute various processes according to a computer program. The print control section 38 may be composed of one or more dedicated hardware circuits such as an application-specific integrated circuit that executes at least a part of various processes. The print control section 38 may be composed of a circuit including a combination of a processor and a hardware circuit. The processor includes a CPU and memory, such as RAM and ROM. The memory stores program code or instructions that are configured to cause the CPU to perform a process. Memory, that is, a computer readable medium, includes any available readable medium that can be accessed by a general-purpose or dedicated computer.

The print control section 38 communicates with the drying device 13. The print control section 38 may transmit various signals to the drying device 13. The print control section 38 notifies a state of the printing device 12 by transmitting signals to the drying device 13. The print control section 38 receives various signals from the drying device 13. The print control section 38 can grasp the state of the drying device 13 by receiving signals from the drying device 13.

### Drying Device

The drying device 13 has a winding unit 41. The winding unit 41 is configured to wind up the medium 99. The winding unit 41 forms a roll body by winding the medium 99.

The winding unit 41 has a winding case 42. The winding case 42 accommodates a second roll body R2. The second roll body R2 is a roll body in which the printed medium 99 is wound over.

The winding unit 41 has a winding section 43. The winding section 43 winds the medium 99. Specifically, the winding section 43 winds the dried medium 99. The winding section 43 has a winding shaft 44. The winding shaft 44 is accommodated in the winding case 42. The winding shaft 44 rotatably supports the second roll body R2. As the winding shaft 44 rotates, the medium 99 is wound. In other words, the winding shaft 44 rotates and the second roll body R2 rotates. The medium 99 is transported in the drying device 13 by being wound by the winding section 43.

The winding section 43 is driven to wind the medium 99 at a speed higher than that of the transport section 32. In other words, the winding section 43 is driven so that the winding speed is higher than the transport speed. By this, tension is applied to the medium 99 between the transport section 32 and the winding section 43. If tension is applied to the medium 99, the posture of medium 99 is stabilized. In one example, applying tension to medium 99 makes it easier to pull the medium 99 off the belt 35.

The winding section 43 may have a dancer roller 45. The dancer roller 45 may be located inside the winding case 42 or may be located outside the winding case 42. The medium 99 is wound around the dancer roller 45. Specifically, the dancer roller 45 is wound with the medium 99 before it is wound onto the winding shaft 44. The dancer roller 45 is configured to be displaceable. The dancer roller 45 adjusts the tension applied to the medium 99 by being displaced. By this, the winding shaft 44 is stabilized, and the medium 99 is easier to wind up.

The drying device 13 is equipped with a drying unit 46. The drying unit 46 is configured to dry the medium 99. The drying unit 46 dries the medium 99 printed by the printing device 12. After being dried by the drying unit 46, the medium 99 is wound by the winding unit 41.

The drying unit 46 has a drying furnace 47. The drying furnace 47 is adjacent to the winding case 42. In one example, the drying furnace 47 is arrange with the winding case 42 in the transport direction D1. The printed medium 99 enters the drying furnace 47. The medium 99 transported from the printing device 12 enters the drying furnace 47. In the drying furnace 47, the medium 99 is transported by the transport section 32 and the winding section 43.

The drying unit 46 has a heating section 48. The heating section 48 is accommodated in the drying furnace 47. The heating section 48 heats the medium 99 in the drying furnace 47. By this, the liquid adhering to the medium 99 is evaporated. As a result, the color components are fixed to the medium 99. The heating section 48 will be described later in detail.

The drying unit 46 may have an exhaust duct 49. The exhaust duct 49 is a duct for exhausting air from the drying furnace 47. The exhaust duct 49 extends from the drying furnace 47. The exhaust duct 49 is attached to the drying furnace 47. In one example, the exhaust duct 49 is attached to the upper surface of drying furnace 47. By this, steam in the drying furnace 47 is easily exhausted. This is because steam tends to drift upward by being heated by the heating section 48. As the steam is exhausted from drying furnace 47, the drying of medium 99 is accelerated.

The drying unit 46 may have an exhaust fan 50. The exhaust fan 50 is a fan that exhausts air from the drying furnace 47. The exhaust fan 50 exhausts air from the drying furnace 47 through the exhaust duct 49. The exhaust fan 50 is attached to the drying furnace 47. In one example, the exhaust fan 50 is attached on the upper surface of the drying furnace 47. The exhaust fan 50 is attached to the exhaust duct 49. The exhaust fan 50 may be located outside the exhaust duct 49 or may be located inside the exhaust duct 49.

The drying unit 46 may have one or more drying guide rollers. In one example, the drying unit 46 has a first drying guide roller 51 and a second drying guide roller 52. The drying guide roller is configured to guide the medium 99 in the same manner as the print guide roller. The drying guide roller guides the medium 99 by making contact with the medium 99. The drying guide roller guide the medium 99 from the printing device 12 to the drying device 13 or guides the medium 99 from the drying unit 46 to the winding unit 41.

The drying guide roller may be located inside the drying furnace 47 or outside the drying furnace 47. In one example, the first drying guide roller 51 and the second drying guide roller 52 are located outside the drying furnace 47. The first drying guide roller 51 guides the medium 99 so that the medium 99 is supplied into the drying furnace 47 from outside the drying furnace 47, for example. In one example, the first drying guide roller 51 guides the medium 99 transported from the printing device 12 into the drying furnace 47. The second drying guide roller 52 guides the medium 99 so that the medium 99 is discharged from the inside of the drying furnace 47 to the outside of the drying furnace 47, for example. Specifically, the second drying guide roller 52 guides the dried medium 99 outside of the drying furnace 47.

The drying unit 46 has a drying control section 53. The drying control section 53 controls the drying unit 46. Specifically, the drying control section 53 controls the heating section 48 and the exhaust fan 50. The drying control section 53 may control the winding unit 41 in addition to the drying unit 46. The drying control section 53 may control, for example, the winding section 43. Similarly to the print control section 38, the drying control section 53 may be composed of a processor, a hardware circuit, or a circuit including a combination thereof.

The drying control section 53 may communicate with the printing device 12. Specifically, the drying control section 53 communicates with the print control section 38. The drying control section 53 transmits various signals to the print control section 38. The drying control section 53 notifies a state of the drying device 13 by transmitting signals to the print control section 38. The drying control section 53 receives various signals from the print control section 38. The drying control section 53 can grasp a state of the printing device 12 by receiving signals from the print control section 38.

Next, the heating section 48 will be described. The heating section 48 heats the medium 99 to maintain the medium 99 in a high-temperature state in order to dry the medium 99. The heating section 48 heats the medium 99 so that the temperature of the medium 99 is raised rapidly. By rapidly raising the temperature of the medium 99, an increase in the size of drying furnace 47 and a decrease in drying efficiency are suppressed. When the temperature of the medium 99 is gradually increased, it is necessary to increase the size of the drying furnace 47 or to reduce the transport speed.

The heating section 48 heats the medium 99 at a high temperature in order to rapidly raise the temperature of the medium 99. On the other hand, when rapidly raising the temperature of medium 99, there is concern that the medium 99 may be excessively heated. In this case, the medium 99 may deteriorate. Therefore, the heating section 48 heats the medium 99 so that the medium 99 is maintained in a high-temperature state while suppressing deterioration of the medium 99. In one example, the heating section 48 heats the medium 99 so that the medium 99 is maintained at 150 degrees Celsius or more to dry the medium 99 printed with pigment ink. In a case where the medium 99 is a blended fabric of 65% polyester and 35% cotton, if the temperature of the medium 99 exceeds 170 degrees Celsius, there is concern that the medium 99 may deteriorate. For example, if the temperature of the medium 99 exceeds 170 degrees Celsius, there is concern that the medium 99 may become yellowed. The heating section 48 heats the medium 99 so that the temperature of the medium 99 is maintained between 150 and 170 degrees Celsius.

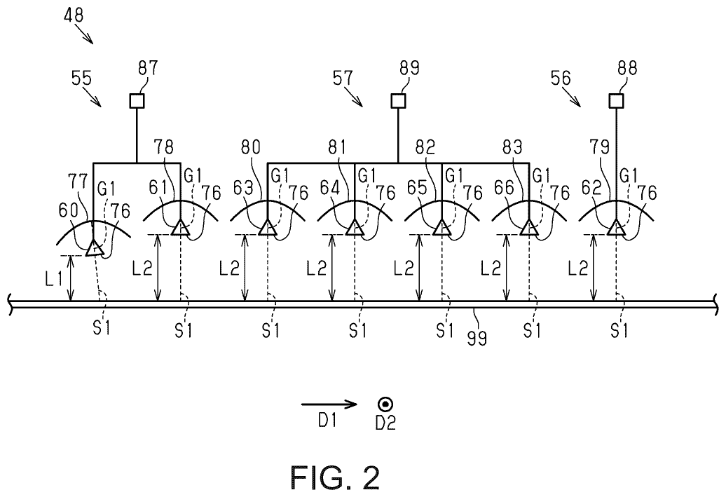

As shown in FIG. 2, the heating section 48 has a plurality of heating mechanisms. The heating section 48 has one upstream heating mechanism 55, one downstream heating mechanism 56, and one intermediate heating mechanism 57. The plurality of heating mechanisms is arranged in the transport direction D1. Specifically, the upstream heating mechanism 55, the intermediate heating mechanism 57, and the downstream heating mechanism 56 are arranged in the transport direction D1 in this order. Therefore, the downstream heating mechanism 56 is located downstream from the upstream heating mechanism 55 in the transport direction D1. The intermediate heating mechanism 57 is located between the upstream heating mechanism 55 and the downstream heating mechanism 56 in the transport direction D1.

The heating mechanism has one or more heating members. The heating members are configured to heat the medium 99. The upstream heating mechanism 55 has two upstream heating members. The downstream heating mechanism 56 has one downstream heating member. The intermediate heating mechanism 57 has four intermediate heating members. In one example, the upstream heating mechanism 55 has a first upstream heating member 60 and a second upstream heating member 61. The downstream heating mechanism 56 has a first downstream heating member 62. The intermediate heating mechanism 57 has a first intermediate heating member 63, a second intermediate heating member 64, a third intermediate heating member 65, and a fourth intermediate heating member 66.

The upstream heating mechanism 55 has the upstream heating members located so that a distance between the upstream heating members and medium 99 is a predetermined distance. In one example, the upstream heating mechanism 55 has the first upstream heating member 60 located such that a vertical distance to the medium 99 is a first distance L1. The upstream heating mechanism 55 has the second upstream heating member 61 located such that a vertical distance to the medium 99 is a second distance L2. The second upstream heating member 61 may be located such that the vertical distance to the medium 99 is the first distance L1. The second distance L2 is larger than the first distance L1. In one example, the first distance L1 is 58 mm. The second distance L2 is 68 mm.

The heating member can easily heat the medium 99 the smaller the distance to the medium 99. In other words, the smaller the distance between the heating member and the medium 99 is, the more easily the temperature of the medium 99 rises. Therefore, the first upstream heating member 60 can easily heat the medium 99 than the second upstream heating member 61.

The downstream heating mechanism 56 has the downstream heating member located so that the distance to the medium 99 is larger than a predetermined distance. In one example, the downstream heating mechanism 56 has the first downstream heating member 62 located such that the vertical distance to the medium 99 is the second distance L2. The distance between the first downstream heating member 62 and the medium 99 need only to be larger than the first distance L1. Therefore, the first upstream heating member 60 heats the medium 99 more easily than the downstream heating member.

The intermediate heating mechanism 57 has the intermediate heating members located so that the distance to the medium 99 is larger than a predetermined distance. In one example, the intermediate heating mechanism 57 has the first intermediate heating member 63 located such that the vertical distance to the medium 99 is the second distance L2. The intermediate heating mechanism 57 has the second intermediate heating member 64 located such that the vertical distance from the medium 99 is the second distance L2. The intermediate heating mechanism 57 has the third intermediate heating member 65 located such that the vertical distance from the medium 99 is the second distance L2. The intermediate heating mechanism 57 has the fourth intermediate heating member 66 located such that the vertical distance from the medium 99 is the second distance L2. The distances between the first intermediate heating member 63 and the medium 99, between the second intermediate heating member 64 and the medium 99, between the third intermediate heating member 65 and the medium 99, and between the fourth intermediate heating member 66 and the medium 99 need only to be larger than the first distance L1, and may be different from each other. Therefore, the first upstream heating member 60 heats the medium 99 more easily than the intermediate heating members.

The plurality of the heating members are arranged in the transport direction D1. In one example, the plurality of the heating members are arranged at equal intervals in the transport direction D1. For example, the plurality of heating members are arranged at 140 mm intervals. The first upstream heating member 60, the second upstream heating member 61, the first intermediate heating member 63, the second intermediate heating member 64, the third intermediate heating member 65, the fourth intermediate heating member 66, and the first downstream heating member 62 are arranged in this order in the transport direction D1. The first upstream heating member 60 is located at the most upstream location among the plurality of the heating members. The first downstream heating member 62 is located at the most downstream location among the plurality of the heating members. Among the plurality of the heating members, the heating member located most upstream in the transport direction D1 is located to be closest to the medium 99. By this, the heating section 48 can rapidly raise the temperature of the portion of the medium 99 entering the drying furnace 47 immediately after it enters the drying furnace 47. Among the plurality of heating members, the heating members other than the heating member located on the most upstream side in the transport direction D1 are located at location relatively distant from the medium 99. By this, it reduces concern that the heating section 48 will excessively heats the medium 99.

The heating members are infrared heaters. Each of the plurality of the heating members has a similar configuration. Therefore, each of the first upstream heating member 60, the second upstream heating member 61, the first intermediate heating member 63, the second intermediate heating member 64, the third intermediate heating member 65, the fourth intermediate heating member 66, and the first downstream heating member 62 is the infrared heater. The heating member heats the medium 99 by irradiating infrared rays on the medium 99. The heating members are located to face the printed surface of the medium 99. In one example, the heating members are located so as to face the upper surface of the medium 99. The heating members irradiate infrared rays on the printed surface of the medium 99. The heating members are not limited to the infrared heaters, and may be, for example, blowers that blow hot air onto the medium 99.

The heating members are driven to as to heat the medium 99 at a predetermined set temperature. The set temperature is a target temperature of the heating members. For example, when the set temperature is 400 degrees Celsius, the heating members are driven so as to heat the medium 99 at 400 degrees Celsius.

The upstream heating members are driven so as to heat the medium 99 at a temperature higher than that of the intermediate heating members. The set temperature of the upstream heating members is higher than the set temperature of the intermediate heating members. In one example, a set temperature of the first upstream heating member 60 is higher than a set temperature of the first intermediate heating member 63, a set temperature of the second intermediate heating member 64, a set temperature of the third intermediate heating member 65, and a set temperature of the fourth intermediate heating member 66. A set temperature of the second upstream heating member 61 is higher than the set temperature of the first intermediate heating member 63, the set temperature of the second intermediate heating member 64, the set temperature of the third intermediate heating member 65, and the set temperature of the fourth intermediate heating member 66.

The higher the set temperature is, the easier it is for the heating members to heat the medium 99. In other words, the higher the set temperature of the heating member is, the easier it is for the temperature of the medium 99 to rise. Therefore, the upstream heating members can heat the medium 99 more easily than the intermediate heating members. By this, the heating section 48 can rapidly raise the temperature of the portion of the medium 99 entering the drying furnace 47 immediately after it enters the drying furnace 47. In addition, since the set temperature of the intermediate heating members is lower than the set temperature of the upstream heating members, the concern that the medium 99 will be excessively heated is reduced.

The downstream heating member is driven so as to heat the medium 99 at a temperature higher than that of the intermediate heating members. The set temperature of the downstream heating member is higher than the set temperature of the intermediate heating members. In one example, a set temperature of the first downstream heating member 62 is higher than the set temperature of the first intermediate heating member 63, the set temperature of the second intermediate heating member 64, the set temperature of the third intermediate heating member 65, and the set temperature of the fourth intermediate heating member 66.

A portion of the medium 99 to be heated by the downstream heating member tends to be cooled by the outside air. In this regard, since the set temperature of the downstream heating member is higher than the set temperature of the intermediate heating members, the concern that the temperature of medium 99 will drop is reduced.

The upstream heating members are driven so as to heat the medium 99 at a higher temperature than the downstream heating member. The set temperature of the upstream heating members is higher than the set temperature of the downstream heating member. In one example, the set temperature of the first upstream heating member 60 is higher than the set temperature of the first downstream heating member 62. The set temperature of the second upstream heating member 61 is higher than the set temperature of the first downstream heating member 62. By this, the heating section 48 can rapidly raise the temperature of the portion of the medium 99 entering the drying furnace 47 immediately after it enters the drying furnace 47.

A capacity of the intermediate heating members may be smaller than a capacity of the upstream heating members and a capacity of the downstream heating member. In one example, a capacity of the first intermediate heating member 63, a capacity of the second intermediate heating member 64, a capacity of the third intermediate heating member 65, and a capacity of the fourth intermediate heating member 66 are smaller than a capacity of the first upstream heating member 60 and a capacity of the second upstream heating member 61. The capacity of the first intermediate heating member 63, the capacity of the second intermediate heating member 64, the capacity of the third intermediate heating member 65, and the capacity of the fourth intermediate heating member 66 are smaller than a capacity of the first downstream heating member 62. Since the set temperature of the intermediate heating members is relatively low, heating members with smaller capacities can be applied to the intermediate heating members. By this, power consumption of the heating section 48 can be reduced. Among the plurality of the intermediate heating members, some of the intermediate heating members can be a smaller capacity than the capacity of the upstream heating members and the capacity of the downstream heating member.

The set temperature is set by the drying control section 53. The set temperature of the upstream heating members is set by the drying control section 53, so as to be higher than the set temperature of the intermediate heating members. The set temperature of the downstream heating member is set by the drying control section 53, so as to be higher than the set temperature of the intermediate heating members. The set temperature of the upstream heating members is set by the drying control section 53, so as to be higher than the set temperature of the downstream heating member.

The set temperature may be set for each heating mechanism. The set temperature may be set for each heating member. In one example, the set temperature is set for each of the upstream heating mechanism 55, the intermediate heating mechanism 57, and the downstream heating mechanism 56. Therefore, the set temperature of the first upstream heating member 60 and the set temperature of the second upstream heating member 61 are the same. The set temperature of the first intermediate heating member 63, the set temperature of the second intermediate heating member 64, the set temperature of the third intermediate heating member 65, and the set temperature of the fourth intermediate heating member 66 are the same.

The heating members extend in a width direction D2. The width direction D2 is a direction different from the transport direction D1. The width direction D2 is a direction that serves as an index indicating the width of the medium 99. By extending in the width direction D2, the heating members irradiate infrared rays over the width of the medium 99.

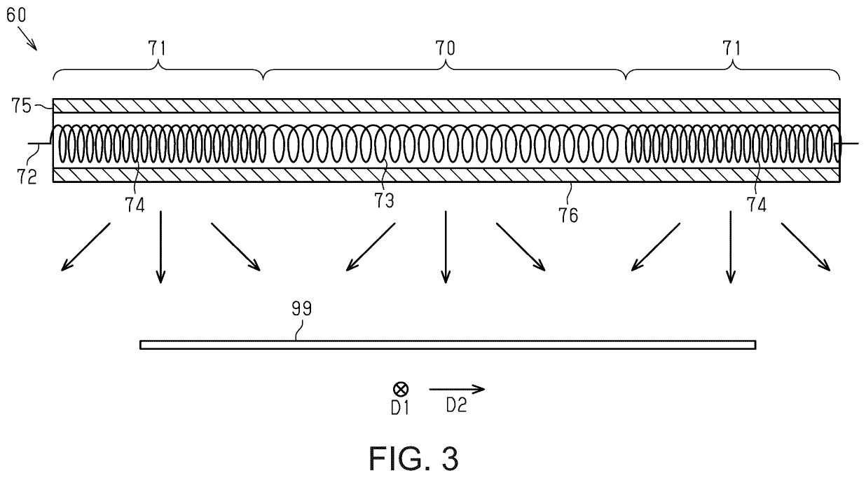

As shown in FIG. 3, the heating members are configured so as to be larger than the entire width of the medium 99 in the width direction D2. Specifically, the heating members are configured so as to be elongated longer than the maximum width of the medium 99 that the drying device 13 can handle. Although the first upstream heating member 60 is illustrated in FIG. 3, the other heating members are also configured so as to be elongated longer than the maximum width of the medium 99. In one example, when the medium 99 is viewed from above, the heating members are elongated so that both ends of the heating members protrude from the medium 99 by 100 mm or more each.

The heating members irradiate infrared rays radially. For example, the heating members irradiate infrared rays as indicated by the black arrows in FIG. 3. In the width direction D2, a portion located at the end of the medium 99 tends to receive a smaller amount of heat from the heating members than a portion located at the center of the medium 99. In this regard, since the heating members are elongated in the width direction D2, gradient of the amount of heat received by the medium 99 is reduced.

Each of the heating members has one central portion 70 and tow end portions 71. The central portion 70 is located at the center of the heating member in the width direction D2. The end portions 71 are potions located at the both ends of the heating member in the width direction D2. Two end portions 71 are located to sandwich the central portion 70 in the width direction D2. In one example, the two end portions 71 are portions that are up to 400 mm from each end of the heating member.

The heating member is configured such that the temperature of the end portions 71 is higher than the temperature of the central portion 70. Specifically, the heating member is configured such that the amount of infrared rays produced from the end portions 71 is larger than an amount of infrared rays produced from the central portion 70. For example, the heating member may be configured such that the output of the heating member of the end portions 71 is 120% or more than the output of that of the central portion 70. By this, gradient of the amount of heat received by the medium 99 is reduced. The heating member may be driven so that the temperature of the central portion 70 reaches the set temperature or the temperature of the end portions 71 reaches the set temperature.

The heating member has an electric heating wire 72. The electric heating wire 72 generates heat when an electric current flows through it. The electric heating wire 72 is, for example, a winding wire. The electric heating wire 72 extends in the width direction D2. The electric heating wire 72, in the width direction D2, is configured such that the density of the portions located at the ends is greater than the density of the portion located in the center. For example, the electric heating wire 72 is configured such that the number of turns per unit length in the portion corresponding to the central portion 70 is smaller than the number of turns per unit length in a portion corresponding to the end portions 71. Specifically, the electric heating wire 72 has one first density portion 73 and two second density portions 74. The first density portion 73 is located in the center in the width direction D2. The first density portion 73 corresponds to the central portion 70 in the electric heating wire 72. The second density portions 74 are located at end portions in the width direction D2. The second density portions 74 correspond to the end portions 71 in the electric heating wire 72. The density of the second density portions 74 are greater than the density of the first density portion 73. The electric heating wire 72 causes the temperature of the end portions 71 to be higher than that of the central portion 70 in the heating member.

Each of the heating members has a cylindrical member 75. The cylindrical member 75 accommodates the electric heating wire 72. The cylindrical member 75 is configured to irradiate infrared rays by being heated by the electric heating wire 72. The cylindrical member 75 is made of ceramic, for example. The cylindrical member 75 extends in the width direction D2. The cylindrical member 75 has a triangular shape when viewed from the width direction D2. In this case, rigidity of the cylindrical member 75 is increased as compared with the case where the cylindrical member 75 has a cylindrical shape. In other words, the heating member is less likely to bend in the width direction D2.

Since the cylindrical member 75 is a triangular shaped cylinder, it has three circumferential surfaces. The three circumferential surfaces include a bottom surface 76. In other words, the cylindrical member 75 has the bottom surface 76. The cylindrical member 75 is located so that the bottom surface 76 faces the medium 99. Specifically, the cylindrical member 75 is located such that the bottom surface 76 faces downward. By this, infrared rays are more easily irradiated to the medium 99 compared to the case where the corner portion of the cylindrical member 75 faces the medium 99.

As shown in FIG. 2, the first upstream heating member 60 may be located such that the bottom surface 76 is directed downstream in the transport direction D1. The first upstream heating member 60 may be located such that a perpendicular line S1 extending from the bottom surface 76 of the first upstream heating member 60 extends toward the downstream in the transport direction D1. In this case, the first upstream heating member 60 irradiates infrared rays to a radiation region where the second upstream heating member 61 irradiates infrared rays. In other words, the radiation region of the first upstream heating member 60 and the radiation region of the second upstream heating member 61 overlap each other. By this, the temperature of medium 99 entering the drying furnace 47 rises rapidly. In one example, the first upstream heating member 60 is located such that the perpendicular line S1 is inclined from 1 to 10 degrees with respect to the vertical direction of the medium 99. Desirably, the first upstream heating member 60 is located such that the perpendicular line S1 is inclined by 6 degrees with respect to the vertical direction of the medium 99. The bottom surface 76 of the first upstream heating member 60 is directed downstream in the transport direction D1 while facing the medium 99. The other heating members, except for the first upstream heating member 60, are located such that the perpendicular line S1 extends perpendicular to the medium 99. In other words, the other heating members, except for the first upstream heating member 60, are located such that each of their bottom surfaces 76 are parallel to the medium 99.

The heating mechanism has one or more reflective plates. In one example, the heating mechanism has the same number of reflective plates as the heating members. The upstream heating mechanism 55 has two upstream reflective plates. The downstream heating mechanism 56 has one downstream reflective plate. The intermediate heating mechanism 57 has four intermediate reflective plates. Specifically, the upstream heating mechanism 55 has a first upstream reflective plate 77 and a second upstream reflective plate 78. The downstream heating mechanism 56 has a first downstream reflective plate 79. The intermediate heating mechanism 57 has a first intermediate reflective plate 80, a second intermediate reflective plate 81, a third intermediate reflective plate 82, and a fourth intermediate reflective plate 83.

The reflective plates are located so as to reflect infrared rays generated from the heating members toward the medium 99. The upstream reflective plates reflect infrared rays generating from the upstream heating members toward the medium 99. The downstream reflective plate reflects infrared rays generated from the downstream heating member toward the medium 99. The intermediate reflective plates reflect infrared rays generated from the intermediate heating members toward the medium 99. Specifically, the first upstream reflective plate 77 reflects infrared rays generated from the first upstream heating member 60 toward the medium 99. The second upstream reflective plate 78 reflects infrared rays generated from the second upstream heating member 61 toward the medium 99. The first downstream reflective plate 79 reflects infrared rays generated from the first downstream heating member 62 toward the medium 99. The first intermediate reflective plate 80 reflects the infrared rays generated from the first intermediate heating member 63 toward the medium 99. The second intermediate reflective plate 81 reflects infrared rays generated from the second intermediate heating member 64 toward the medium 99. The third intermediate reflective plate 82 reflects infrared rays generated from the third intermediate heating member 65 toward the medium 99. The fourth intermediate reflective plate 83 reflects infrared rays generated from the fourth intermediate heating member 66 toward the medium 99.

The first upstream reflective plate 77 may be located to reflect infrared rays generated from the first upstream heating member 60 toward in the downstream in the transport direction D1. The first upstream reflective plate 77 may be located such that its optical axis G1 is directed downstream in the transport direction D1. In this case, the first upstream reflective plate 77 reflects infrared rays generated from the first upstream heating member 60 toward a radiation region where the second upstream heating member 61 irradiates infrared rays. In other words, the radiation region of the first upstream heating member 60 and the radiation region of the second upstream heating member 61 overlap each other. By this, the temperature of medium 99 entering the drying furnace 47 rises rapidly. In one example, the first upstream reflective plate 77 is located such that the optical axis G1 is inclined by 1 to 10 degrees with respect to the vertical direction of the medium 99. Desirably, the first upstream reflective plate 77 is located such that the optical axis G1 is inclined by 6 degrees with respect to the vertical direction of the medium 99. The first upstream reflective plate 77 is located such that the optical axis G1 overlaps with the perpendicular line S1 of the first upstream heating member 60. The reflective plates other than the first upstream reflective plate 77 are located such that their optical axes G1 are perpendicular to medium 99. Other reflective plates except the first upstream reflective plate 77 are located so that each optical axis G1 overlaps with the perpendicular line S1. When the optical axis G1 overlaps with the perpendicular line S1, the reflection efficiency of infrared rays by the reflective plate is improved.

The heating mechanism has a controller. Specifically, the upstream heating mechanism 55 has an upstream controller 87. The downstream heating mechanism 56 has a downstream controller 88. The intermediate heating mechanism 57 has an intermediate controller 89. The controllers may be composed of a processor or a hardware circuit.

The controllers control the heating members so that the heating members reach the set temperature. In other words, the controllers control the temperature of the heating members. In one example, the controllers control the temperature of the heating members by controlling the energizing duty of the heating members.

The upstream controller 87 controls the temperature of the upstream heating members. Specifically, the upstream controller 87 uniformly controls the temperature of the first upstream heating member 60 and the temperature of the second upstream heating member 61. The upstream controller 87 controls both the first upstream heating member 60 and the second upstream heating member 61 at a common set temperature. The upstream controller 87 controls the first upstream heating member 60 and the second upstream heating member 61 so that an average temperature of the first upstream heating member 60 and the second upstream heating member 61 reaches the set temperature. By having one upstream controller 87 that controls the first upstream heating member 60 and the second upstream heating member 61, the upstream heating mechanism 55 does not need to have multiple upstream controllers 87. Therefore, the configuration of the upstream heating mechanism 55 is simplified.

The downstream controller 88 controls the temperature of the downstream heating member. Specifically, the downstream controller 88 controls the temperature of the first downstream heating member 62. The intermediate controller 89 controls the temperature of the intermediate heating members. Specifically, the intermediate controller 89 uniformly controls the temperature of the first intermediate heating member 63, the temperature of the second intermediate heating member 64, the temperature of the third intermediate heating member 65, and the temperature of the fourth intermediate heating member 66. The intermediate controller 89 controls the temperature of the first intermediate heating member 63, the second intermediate heating member 64, the third intermediate heating member 65, and the fourth intermediate heating member 66 at a common set temperature. The intermediate controller 89 controls the first intermediate heating member 63, the second intermediate heating member 64, the third intermediate heating member 65, and the fourth intermediate heating member 66 so that an average temperature of the first intermediate heating member 63, the second intermediate heating member 64, the third intermediate heating member 65, and the fourth intermediate heating member 66 reaches the set temperature. By having one intermediate controller 89 that controls the first intermediate heating member 63, the second intermediate heating member 64, the third intermediate heating member 65, and the fourth intermediate heating member 66, the intermediate heating mechanism 57 does not need to have multiple intermediate controllers 89. Therefore, the configuration of the intermediate heating mechanism 57 is simplified.

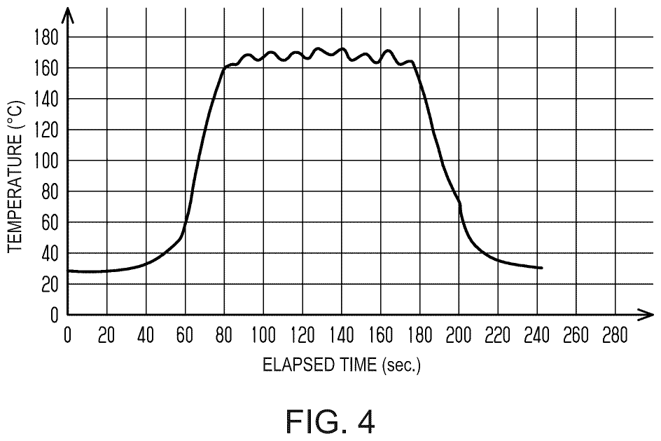

As shown in FIG. 4, the drying device 13 dries the medium 99 by maintaining the medium 99 at 150 degrees Celsius or more and 170 degrees Celsius or less for a long time. The graph shown in FIG. 4 shows the temperature change of the medium 99 with respect to elapsed time. The temperature of the medium 99 is measured by a thermocouple attached to the medium 99.

In the example shown in FIG. 4, the drying device 13 maintains the medium 99 at a temperature of 150 degrees Celsius or more and 170 degrees Celsius or less for 81.2 seconds. The set temperature of the first upstream heating member 60 and the set temperature of the second upstream heating member 61 are, for example, 490 degrees Celsius. The set temperature of the first intermediate heating member 63, the set temperature of the second intermediate heating member 64, the set temperature of the third intermediate heating member 65, and the set temperature of the fourth intermediate heating member 66 are, for example, 395 degrees Celsius. The set temperature of the first downstream heating member 62 is, for example, 445 degrees Celsius. The transport speed of the medium 99 is, for example, 10.2 mm/sec. According to this example, the color difference ΔE00 between the medium 99 before drying and the medium 99 after drying is 0.72. If the color difference ΔE00 is 2.00 or less, it can be said that the medium 99 is not deteriorated.

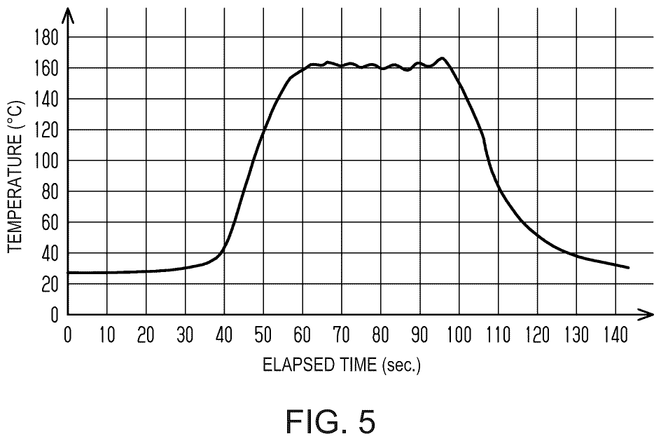

As shown in FIG. 5, the drying device 13 dries the medium 99 by maintaining the medium 99 at 150 degrees Celsius or more and 170 degrees Celsius or less for a long time. The graph shown in FIG. 5 shows the temperature change of the medium 99 with respect to elapsed time, similar to the graph shown in FIG. 4.

In the example shown in FIG. 5, the drying device 13 maintains the medium 99 at a temperature of 150 degrees Celsius or more and 170 degrees Celsius or less for 45.0 seconds. The set temperature of the first upstream heating member 60 and the set temperature of the second upstream heating member 61 are, for example, 500 degrees Celsius. The set temperature of the first intermediate heating member 63, the set temperature of the second intermediate heating member 64, the set temperature of the third intermediate heating member 65, and the set temperature of the fourth intermediate heating member 66 is, for example, 370 degrees Celsius. The set temperature of the first downstream heating member 62 is, for example, 455 degrees Celsius. The transport speed of the medium 99 is, for example, 20.0 mm/sec. According to this example, the color difference ΔE00 between the medium 99 before drying and the medium 99 after drying is 0.63.

### Operation and Effects of Embodiments

Next, the operation and effects of the above embodiments will be described. (1) The upstream heating mechanism 55 has the first upstream heating member 60 located at a predetermined distance from the medium 99. The downstream heating mechanism 56 has the downstream heating member located so that the distance to the medium 99 is larger than a predetermined distance. The intermediate heating mechanism 57 has the intermediate heating members located so that the distance to the medium 99 is larger than a predetermined distance. The set temperature of the first upstream heating member 60 is higher than the set temperature of the intermediate heating member. The set temperature of the downstream heating member is higher than the set temperature of the intermediate heating members. In the drying device 13, the smaller the distance between the heating members and medium 99 is, the more easily the temperature of medium 99 rises. In the drying device 13, the higher the set temperature of the heating members is, the more easily the temperature of medium 99 rises. According to the above configuration, by the first upstream heating member 60 whose distance from the medium 99 is relatively small and whose set temperature is relatively high, the temperature of the medium 99 rises rapidly. By the intermediate heating members whose distance from the medium 99 is relatively large and whose set temperature is relatively low, concern that the temperature of the medium 99 will rise excessively is reduced. By the downstream heating member whose distance from the medium 99 is a relatively large and whose set temperature is relatively high, concern that the temperature of the medium 99 will drop is reduced. In this way, the drying device 13 can effectively dry the medium 99.

(2) The set temperature of the first upstream heating member 60 is higher than the set temperature of the downstream heating member. According to the above configuration, the temperature of the medium 99 is raised rapidly by the first upstream heating member 60.

(3) Each of the upstream heating member, the downstream heating member, and the intermediate heating member is an infrared heater. According to the above configuration, for example, compared to a case where the heating section 48 heats the medium 99 by blowing hot air onto the medium 99, the heating section 48 can more easily heat the medium 99.

(4) The downstream reflective plate is located such that the optical axis G1 of the downstream reflective plate is perpendicular to the medium 99. The intermediate reflective plates are located such that the optical axes G1 of the intermediate reflective plates are perpendicular to the medium 99. The first upstream reflective plate 77 is located such that the optical axis G1 of the first upstream reflective plate 77 is directed downstream in the transport direction D1. According to the above configuration, the radiation region of the first upstream heating member 60 overlaps the radiation region of the heating member located downstream from the first upstream heating member 60, for example, the second upstream heating member 61. By this, the temperature of medium 99 rises rapidly.

(5) Each of the upstream heating member, the downstream heating member, and the intermediate heating members is configured such that, in the width direction D2, the temperature of the end portions 71 is higher than the temperature of the central portion 70. Since infrared rays are radially generated from the heating members, the amount of radiation received by the portions of the medium 99 located at the ends tend to be smaller than the amount of radiation received by the portion of the medium 99 located at the center. In this regard, according to the above configuration, the amount of radiation received by the portions located at the end portions of the medium 99 increases. Therefore, the heating section 48 can uniformly heat the medium 99.

(6) When viewed from the width direction D2, each of the upstream heating member, the downstream heating member, and the intermediate heating members has a substantially triangular shape with the bottom surface 76, and is located such that the bottom surface 76 faces the medium 99. According to the above configuration, the amount of radiation received by the medium 99 is increased.

(7) The first upstream heating member 60 is located such that the bottom surface 76 of the first upstream heating member 60 is directed downstream in the transport direction D1. According to the above configuration, the temperature of the medium 99 is raised rapidly by the first upstream heating member 60 and the heating member located downstream from the first upstream heating member 60, for example, the second upstream heating member 61.

(8) The capacity of the intermediate heating members is smaller than the capacity of the upstream heating member and smaller than the capacity of the downstream heating member. Since the set temperature of the intermediate heating members is relatively low, the capacity of the intermediate heating members can be reduced. Therefore, according to the above configuration, the power consumption of the heating section 48 can be reduced.

### Modifications

The above embodiments may be modified as follows. The above embodiments and the following modifications can be implemented in combination with each other to the extent that they are not technically contradictory.
The heating mechanism may have an equivalent number of the controllers as the heating members. Each of the plurality of heating members may be driven at an individual set temperature.
Similarly to the winding section 43, the feed section 23 may have a dancer roller.
The liquid ejected by the head 28 is not limited to ink, and may be, for example, a liquid in which particles of functional material are dispersed or mixed. For example, the head 28 may eject liquid containing materials such as electrode materials or pixel materials in the form of dispersion or dissolution for use to manufacture liquid crystal displays, electroluminescence displays, surface emitting displays, or the like.
The feed unit 21 has the feed case 22, but the present disclosure is not limited to this, and the first roll body R1 may be provided in an exposed state, for example.
The winding unit 41 has the winding case 42, but the present disclosure is not limited to this, and the second roll body R2 may be provided in an exposed state, for example.
The cylindrical member 75 of the heating member has the triangular shape having vertexes when viewed from the width direction D2. However, it is not limited to this, it may also be a rounded triangular shape without vertexes. In other words, the cylindrical member 75 may only needs to have a substantially triangular shape with the bottom surface 76 when viewed from the width direction D2.

### Technical Ideas

Hereinafter, technical ideas grasped from the above-described embodiments and modifications, and operation and effects thereof will be described.

(A) The drying device includes a drying furnace into which a medium to be transported enters and a heating section that heats the medium in the drying furnace, wherein the heating section has an upstream heating mechanism, a downstream heating mechanism located downstream from the upstream heating mechanism in a transport direction of the medium, and an intermediate heating mechanism located between the upstream heating mechanism and the downstream heating mechanism in the transport direction, the upstream heating mechanism has an upstream heating member located so that a distance between the upstream heating member and the medium is a predetermined distance, the downstream heating mechanism has a downstream heating member located so that a distance between the downstream heating member and the medium is larger than the predetermined distance, the intermediate heating mechanism has an intermediate heating member located so that a distance between the intermediate heating member and the medium is larger than the predetermined distance, a set temperature of the upstream heating member is higher than a set temperature of the intermediate heating member, and a set temperature of the downstream heating member is higher than the set temperature of the intermediate heating member. In the drying device, the smaller the distance between the heating member and the medium is, the more easily the temperature of the medium rises. In the drying device, the higher the set temperature of the heating member is, the more easily the temperature of the medium rises. According to the above configuration, by the upstream heating member whose distance from the medium is relatively small and whose set temperature is relatively high, the temperature of the medium rises rapidly. By the intermediate heating member whose distance from the medium is relatively large and whose set temperature is relatively low, concern that the medium temperature will rise excessively is reduced. By the downstream heating member whose distance from the medium is a relatively large and whose set temperature is relatively high, concern that the temperature of the medium will drop is reduced. In this way, the drying device can effectively dry the medium.

(B) The above drying device may be configured such that the set temperature of the upstream heating member is higher than the set temperature of the downstream heating member. According to the above configuration, the temperature of the medium is raised rapidly by the upstream heating member.

(C) The above drying device may be configured such that each of the upstream heating member, the downstream heating member, and the intermediate heating member is an infrared heater. According to the above configuration, for example, compared to a case where the heating section heats the medium by blowing hot air onto the medium, the heating section can more easily heat the medium.

(D) The above drying device may be configured such that the heating section has an upstream reflective plate that reflects infrared rays generated from the upstream heating member toward the medium, a downstream reflective plate that reflects infrared rays generated from the downstream heating member toward the medium, and an intermediate reflective plate that reflects infrared rays generated from the intermediate heating member toward the medium, the downstream reflective plate is located so that an optical axis of the downstream reflective plate is perpendicular to the medium, the intermediate reflective plate is located so that an optical axis of the intermediate reflective plate is perpendicular to the medium, and the upstream reflective plate is located so that an optical axis of the upstream reflective plate is directed downstream in the transport direction. According to the above configuration, the radiation region of the upstream heating member overlaps the radiation region of the heating member located downstream from the upstream heating member. By this, the temperature of the medium rises rapidly.

(E) The above drying device may be configured such that each of the upstream heating member, the downstream heating member, and the intermediate heating member extends in a width direction, which is a direction different from the transport direction and is configured so that, in the width direction, a temperature of end portions is higher than a temperature of a central portion. Since the infrared rays are radially generated from the heating member, the amount of radiation received by the portions located at the ends of the medium tends to be smaller than the amount of radiation received by the portion located at the center of the medium. In this regard, according to the above configuration, the amount of radiation received by the portions located at the end portions of the medium increases. Therefore, the heating section can uniformly heat the medium.

(F) The above drying device may be configured such that each of the upstream heating member, the downstream heating member, and the intermediate heating member extends in a width direction, which is a direction different from the transport direction and when viewed from the width direction, has substantially a triangular shape with a bottom surface, and the bottom surface is located to face the medium. According to the above configuration, the amount of radiation received by the medium is increased.

(G) The above drying device may be configured such that the upstream heating member is located so that the bottom surface of the upstream heating member is directed downstream in the transport direction. According to the above configuration, by the upstream heating member and the heating member located downstream from the upstream heating member, the temperature of the medium rises rapidly.

(H) The above drying device may be configured such that a capacity of the intermediate heating member is smaller than a capacity of the upstream heating member and smaller than a capacity of the downstream heating member. Since the set temperature of the intermediate heating members is relatively low, the capacity of the intermediate heating members can be reduced. Therefore, according to the above configuration, the power consumption of the heating section can be reduced.

(I) A printing system includes a printing device for printing an image on a medium, and a drying device that dries a printed medium, wherein the printing device has a housing and a printing section configured to print an image on the medium within the housing, the drying device has a drying furnace into which the medium transported from the printing device enters and a heating section that heats the medium in the drying furnace, the heating section has an upstream heating mechanism, a downstream heating mechanism located downstream from the upstream heating mechanism in a transport direction of the medium, and an intermediate heating mechanism located between the upstream heating mechanism and the downstream heating mechanism in the transport direction, the upstream heating mechanism has an upstream heating member located so that a distance between the upstream heating member and the medium is a predetermined distance, the downstream heating mechanism has a downstream heating member located so that a distance between the downstream heating member and the medium is larger than the predetermined distance, the intermediate heating mechanism has an intermediate heating member located so that a distance between the intermediate heating member and the medium is larger than the predetermined distance, a set temperature of the upstream heating member is higher than a set temperature of the intermediate heating member, and a set temperature of the downstream heating member is higher than the set temperature of the intermediate heating member. According to the above configuration, the same effect as that of the drying device described above can be obtained.

What is claimed is:

1. A drying device comprising:
a drying furnace into which a medium to be transported enters and
a heating section that heats the medium in the drying furnace, wherein
the heating section has
an upstream heating mechanism,
a downstream heating mechanism located downstream from the upstream heating mechanism in a transport direction of the medium, and
an intermediate heating mechanism located between the upstream heating mechanism and the downstream heating mechanism in the transport direction,
the upstream heating mechanism has an upstream heating member located so that a distance between the upstream heating member and the medium is a predetermined distance,
the downstream heating mechanism has a downstream heating member located so that a distance between the downstream heating member and the medium is larger than the predetermined distance,
the intermediate heating mechanism has an intermediate heating member located so that a distance between the intermediate heating member and the medium is larger than the predetermined distance,
a set temperature of the upstream heating member is higher than a set temperature of the intermediate heating member, and
a set temperature of the downstream heating member is higher than the set temperature of the intermediate heating member.

2. The drying device according to claim 1, wherein
the set temperature of the upstream heating member is higher than the set temperature of the downstream heating member.

3. The drying device according to claim 1, wherein
each of the upstream heating member, the downstream heating member, and the intermediate heating member is an infrared heater.

4. The drying device according to claim 3, wherein
the heating section has
an upstream reflective plate that reflects infrared rays generated from the upstream heating member toward the medium,
a downstream reflective plate that reflects infrared rays generated from the downstream heating member toward the medium, and
an intermediate reflective plate that reflects infrared rays generated from the intermediate heating member toward the medium,
the downstream reflective plate is located so that an optical axis of the downstream reflective plate is perpendicular to the medium,
the intermediate reflective plate is located so that an optical axis of the intermediate reflective plate is perpendicular to the medium, and
the upstream reflective plate is located so that an optical axis of the upstream reflective plate is directed downstream in the transport direction.

5. The drying device according to claim 3, wherein
each of the upstream heating member, the downstream heating member, and the intermediate heating member
extends in a width direction, which is a direction different from the transport direction and
is configured so that, in the width direction, a temperature of end portions is higher than a temperature of a central portion.

6. The drying device according to claim 3, wherein
each of the upstream heating member, the downstream heating member, and the intermediate heating member
extends in a width direction, which is a direction different from the transport direction and
when viewed from the width direction, has substantially a triangular shape with a bottom surface, and
the bottom surface is located to face the medium.

7. The drying device according to claim 6, wherein
the upstream heating member is located so that the bottom surface of the upstream heating member is directed downstream in the transport direction.

8. The drying device according to claim 3, wherein
a capacity of the intermediate heating member is smaller than a capacity of the upstream heating member and smaller than a capacity of the downstream heating member.

9. A printing system, comprising:
a printing device for printing an image on a medium, and
a drying device that dries a printed medium, wherein
the printing device has
a housing and
a printing section configured to print an image on the medium within the housing,
the drying device has
a drying furnace into which the medium transported from the printing device enters and
a heating section that heats the medium in the drying furnace,
the heating section has
an upstream heating mechanism,
a downstream heating mechanism located downstream from the upstream heating mechanism in a transport direction of the medium, and
an intermediate heating mechanism located between the upstream heating mechanism and the downstream heating mechanism in the transport direction,
the upstream heating mechanism has an upstream heating member located so that a distance between the upstream heating member and the medium is a predetermined distance,
the downstream heating mechanism has a downstream heating member located so that a distance between the downstream heating member and the medium is larger than the predetermined distance,
the intermediate heating mechanism has an intermediate heating member located so that a distance between the intermediate heating member and the medium is larger than the predetermined distance,
a set temperature of the upstream heating member is higher than a set temperature of the intermediate heating member, and
a set temperature of the downstream heating member is higher than the set temperature of the intermediate heating member.
